(19) United States
(12) Patent Application Publication
(10) Pub. No.: US 2024/0265242 A1
(43) Pub. Date: Aug. 8, 2024

(54) COMPUTING APPARATUS, METHOD FOR IMPLEMENTING CONVULUTION OPERATION BY USING COMPUTING APPARATUS, AND RELATED PRODUCT

(71) Applicant: Cambricon (Xi'an) Semiconductor Co., Ltd., Xi'an (CN)

(72) Inventors: Haoyuan HE, Xi'an (CN); Wankai ZHENG, Xi'an (CN); Weilun CHEN, Xi'an (CN); Jinhua TAO, Xi'an (CN)

(21) Appl. No.: 18/565,068

(22) PCT Filed: Jun. 8, 2022
(86) PCT No.: PCT/CN2022/097669

§ 371 Date: Nov. 28, 2023

(30) Foreign Application Priority Data
Jun. 10, 2021 (CN) 202110648346.2

(51) Int. Cl. G06N 3/0464

(52) U.S. Cl. CPC G06N 3/0464

(57) ABSTRACT

The present disclosure discloses a computing apparatus, a method for implementing a convolution operation by using a computing apparatus, and related products. The computing apparatus is included in a combined processing apparatus. The combined processing apparatus further includes an interface apparatus and other processing apparatus. The computing apparatus interacts with other processing apparatus to jointly complete a computing operation specified by a user. The combined processing apparatus further includes a storage apparatus. The storage apparatus is respectively connected to the computing apparatus and other processing apparatus and is configured to store data of the computing apparatus and other processing apparatus. A solution of the present disclosure optimizes a convolution operation and improves operation processing efficiency.

### CROSS REFERENCE OF RELATED APPLICATION

The present application is a 371 of international Application PCT/CN2022/097669, filed Jun. 8, 2022, which claims priority to Chinese Patent Application No. 202110648346.2 with the title of “Computing Apparatus, Method for Implementing Convolution Operation by Using Computing Apparatus, and Related Product” and filed on Jun. 10, 2021. The contents of the applications are incorporated herein by reference in their entireties.

### TECHNICAL FIELD

The present disclosure generally relates to the field of data processing. More specifically, the present disclosure relates to a computing apparatus configured to perform a convolution operation, a method for implementing a convolution operation by using a computing apparatus, a chip, and a board card.

### BACKGROUND

At present, deep learning has become an important branch of machine learning and greatly promotes the development of artificial intelligence (AI). Deep neural network (DNN), as the core technology of the deep learning, has been widely used in many industries.

Convolution layer is one of common hidden layers in a neural network model, and a convolution operation is performed on the convolution layer to extract features of input data. A lot of convolution operations are included in the neural network model, and computing performance of the convolution operations greatly affects computing performance of the whole neural network model. When the neural network model is applied to different fields, such as speech recognition, machine translation, image processing, and the like, sizes of dimensions of an input feature map and a weight corresponding to the neural network model may vary. In order to take full advantage of hardware advantages of a deep learning processor, it is necessary to optimize convolution operations of different scales to improve computing performance of executing the neural network model.

### SUMMARY

To at least solve one or more technical problems mentioned before, the present disclosure provides a computing apparatus in many aspects, where the computing apparatus may effectively improve efficiency of a large-scale convolution operation by dividing an input feature map and a weight into blocks. The convolution operation of the present disclosure may be an operation in various neural network models. These neural network models may be applied to various fields, such as image processing, speech processing, text processing, and the like, and these processing, for example, may include but are not limited to recognition and classification.

A first aspect of the present disclosure provides a computing apparatus configured to perform a convolution operation, where the computing apparatus includes a master processing circuit and a plurality of slave processing circuits. The master processing circuit is configured to: during the convolution operation, broadcast at least one feature map block of an input feature map to a plurality of scheduled slave processing circuits, where the feature map block is obtained by dividing the input feature map into blocks according to a lowest storage dimension. Moreover, each scheduled slave processing circuit is configured to: perform the convolution operation on the feature map block and a corresponding weight block, where the weight block is obtained by dividing a weight into blocks according to an output channel dimension; and return an operation result to the master processing circuit.

A second aspect of the present disclosure provides a chip, including the computing apparatus of any embodiment of the first aspect.

A third aspect of the present disclosure provides a board card, including the chip of any embodiment of the second aspect.

A fourth aspect of the present disclosure provides a method for implementing a convolution operation by using the computing apparatus of any embodiment of the first aspect.

By means of the computing apparatus, chip, board card, and method for implementing the convolution operation by using the computing apparatus provided above, the solution of the embodiments of the present disclosure divides large-scale input feature maps and weights into blocks to adapt to processing capability of a single operation apparatus, so as to make full use of parallel processing capability of deep learning processors and effectively improve efficiency of the convolution operation. Additionally, in some embodiments, the input feature maps and weights may be transferred through different data paths, thus supporting multiple multiplexing methods of the input feature maps and weights, further optimizing the convolution operation, and reducing data throughput.

### BRIEF DESCRIPTION OF DRAWINGS

By reading the following detailed description with reference to drawings, the above-mentioned and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 shows a structural diagram of a board card according to an embodiment of the present disclosure.

FIG. 2 shows a structural diagram of a combined processing apparatus according to an embodiment of the present disclosure.

FIG. 3 shows a schematic diagram of an internal structure of a processor core of a single-core or multi-core computing apparatus according to an embodiment of the present disclosure.

FIG. 4 shows an example of an exemplary convolution operation principle that may be applied to an embodiment of the present disclosure.

FIG. 5 shows a convolution operation process according to an embodiment of the present disclosure.

FIG. 6 shows an exemplary structural diagram of a computing apparatus according to an embodiment of the present disclosure.

FIG. 7 shows a partial structure diagram of a slave processing circuit according to an embodiment of the present disclosure.

FIG. 8 shows an exemplary storage manner of weight data in a second storage circuit according to an embodiment of the present disclosure.

FIG. 9 shows an exemplary flowchart of a convolution operation method according to an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” appear in the claims, specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that the terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context.

Specific implementations of the present disclosure will be described in detail in combination with drawings below.

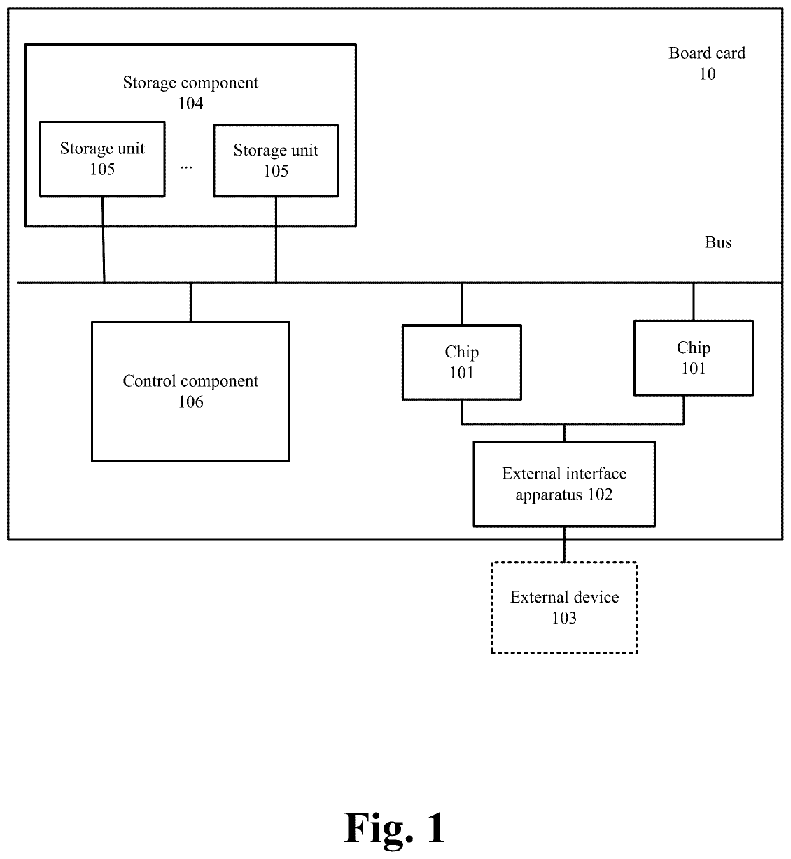

FIG. 1 is a schematic structural diagram of a board card 10 according to an embodiment of the present disclosure. As shown in FIG. 1, the board card 10 includes a chip 101, which is a system on chip (SoC), or called an on-chip system, and integrates one or a plurality of combined processing apparatuses. The combined processing apparatus is an artificial intelligence operation unit, which is configured to support various deep learning algorithms and various machine learning algorithms and meet requirements of intelligent processing in complex scenarios in computer vision, speech, natural language processing, data mining, and other fields. In particular, deep learning technology is widely used in the field of cloud intelligence. A notable feature of cloud intelligence applications is the large amount of input data, which has high requirements for storage capacity and computing power of a platform. The board card 10 of this embodiment is suitable for the cloud intelligent applications and has huge off-chip storage, huge on-chip storage, and great computing power.

The chip 101 is connected to an external device 103 through an external interface apparatus 102. The external device 103 may be, for example, a server, a computer, a camera, a monitor, a mouse, a keyboard, a network card, or a WIFI interface. To-be-processed data may be transferred from the external device 103 to the chip 101 through the external interface apparatus 102. A computing result of the chip 101 may be transferred back to the external device 103 through the external interface apparatus 102. According to different application scenarios, the external interface apparatus 102 may have different interface forms, such as a peripheral component interface express (PCIe) interface, and the like.

The board card 10 further includes a storage component 104 configured to store data. The storage component 104 includes one or a plurality of storage units 105. The storage component 104 is connected to and transfers data to a control component 106 and the chip 101 through a bus. The control component 106 in the board card 10 is configured to regulate and control a state of the chip 101. As such, in an application scenario, the control component 106 may include a micro controller unit (MCU).

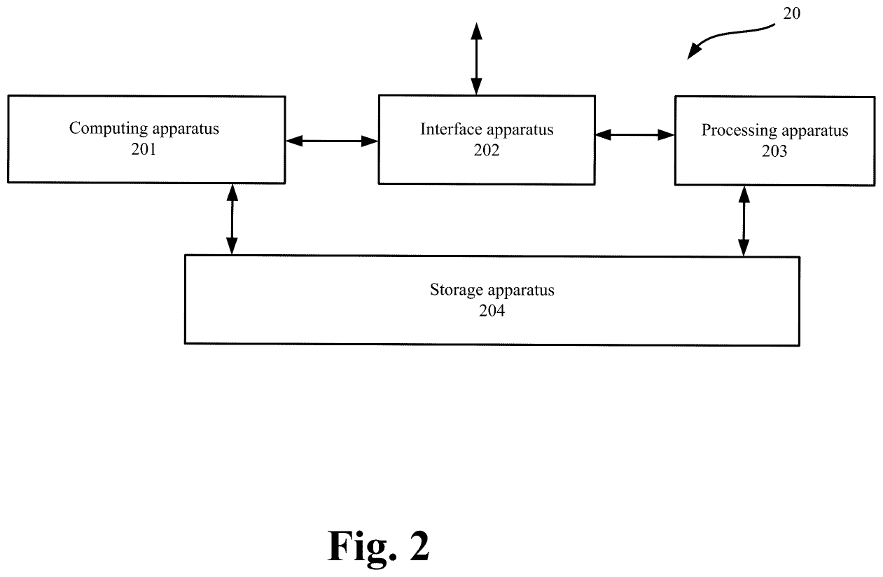

FIG. 2 is a structural diagram of a combined processing apparatus in the chip 101 of this embodiment. As shown in FIG. 2, a combined processing apparatus 20 includes a computing apparatus 201, an interface apparatus 202, a processing apparatus 203, and a storage apparatus 204.

The computing apparatus 201 is configured to perform an operation specified by a user. The computing apparatus 201 is mainly implemented as a single-core intelligent processor or a multi-core intelligent processor and is configured to perform deep learning computing or machine learning computing. The computing apparatus 201 interacts with the processing apparatus 203 through the interface apparatus 202 to jointly complete the operation specified by the user.

The interface apparatus 202 is configured to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general processing apparatus and performs basic controls, including but not limited to, moving data, starting and/or stopping the computing apparatus 201. According to different implementations, the processing apparatus 203 may be a central processing unit (CPU), a graphics processing unit (GPU), or one or more of other general and/or dedicated processors. These processors include but are not limited to a digital signal processor (DSP), an application specific integrated circuit (ASIC), a field-programmable gate array (FPGA), or other programmable logic components, discrete gate or transistor logic components, discrete hardware components, and the like. Moreover, a count of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when considered together, the computing apparatus 201 and the processing apparatus 203 are viewed as forming a heterogeneous multi-core structure.

The storage apparatus 204 is configured to store to-be-processed data. The storage apparatus 204 may be a dynamic random access memory (DRAM), which is a double data rate (DDR) memory with a size of 16G or more than 16G generally. The storage apparatus 204 is configured to save data of the computing apparatus 201 and/or the processing apparatus 203.

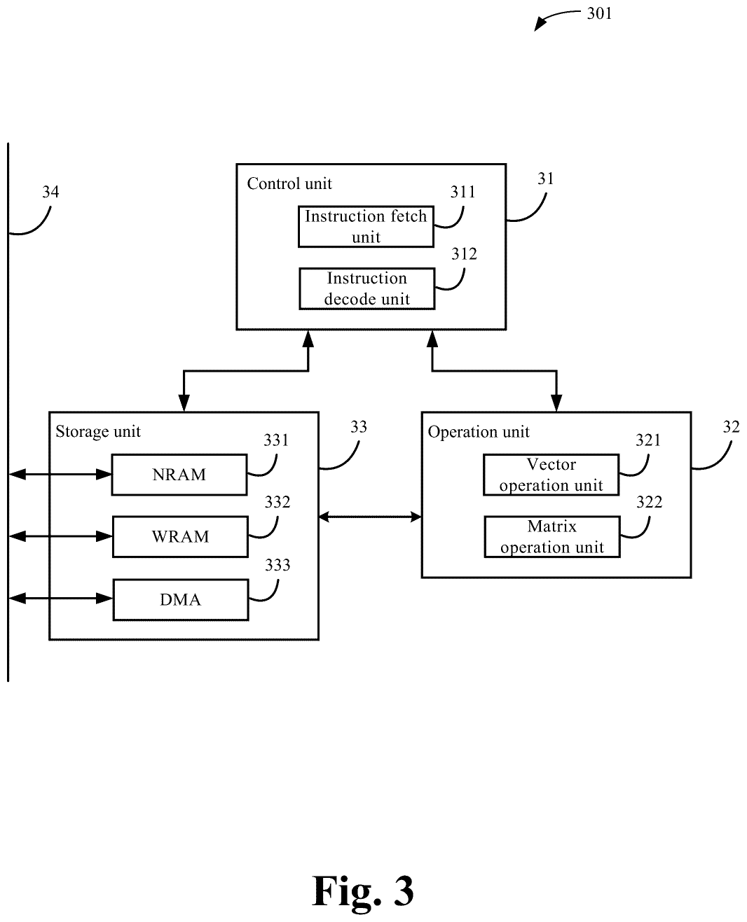

FIG. 3 shows a schematic diagram of an internal structure of a processor core when the computing apparatus 201 is a single-core apparatus or multi-core apparatus. A computing apparatus 301 is configured to process input data in computer vision, speech, natural language, and data mining. The computing apparatus 301 includes three units: a control unit 31, an operation unit 32, and a storage unit 33.

The control unit 31 is configured to coordinate and control work of the operation unit 32 and the storage unit 33 to complete a deep learning task. The control unit 31 includes an instruction fetch unit (IFU) 311 and an instruction decode unit (IDU) 312. The IFU 311 is configured to acquire an instruction from the processing apparatus 203. The IDU 312 is configured to decode the instruction acquired and send a decoding result as control information to the operation unit 32 and the storage unit 33.

The operation unit 32 includes a vector operation unit 321 and a matrix operation unit 322. The vector operation unit 321 is configured to perform a vector operation and supports complex operations such as vector multiplication, addition, and nonlinear conversion. The matrix operation unit 322 is responsible for core computing of deep learning algorithms, such as matrix multiplication and convolution.

The storage unit 33 is configured to store or move related data and includes a neuron storage unit (neuron random access memory (RAM), NRAM) 331, a weight storage unit (weight RAM, WRAM) 332, and a direct memory access (DMA) unit 333. The NRAM 331 is configured to store input neuron, output neuron, and an intermediate result after computing. The WRAM 332 is configured to store a convolution kernel of a deep learning network, which is a weight. The DMA 333 is connected to the DRAM 204 through a bus 34 and is responsible for data moving between the computing apparatus 301 and the DRAM 204.

Based on the above hardware environment, in an aspect, the embodiment of the present disclosure provides a computing apparatus configured to perform a convolution operation, thus optimizing a convolution operation in a neural network model.

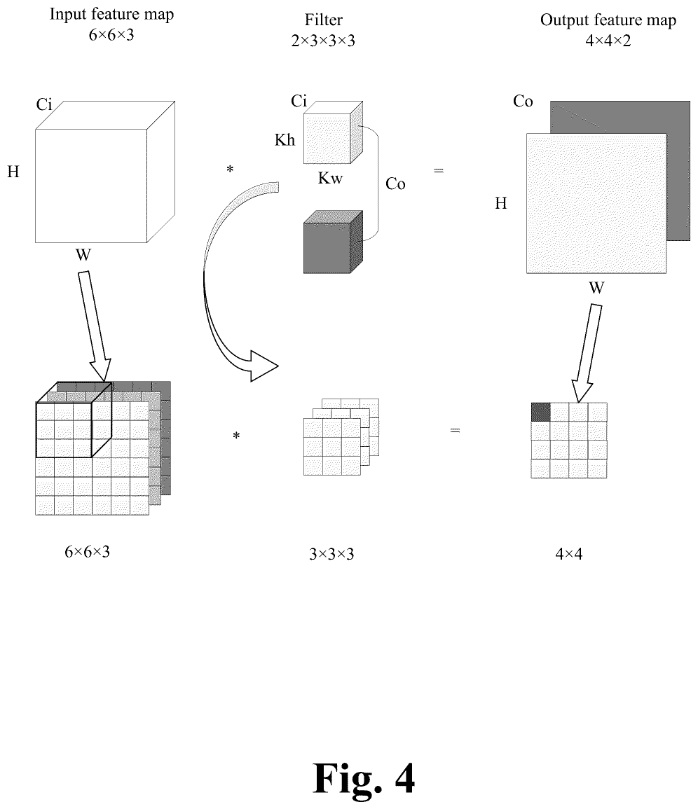

FIG. 4 shows an example of an exemplary convolution operation principle that may be applied to an embodiment of the present disclosure. As shown in the figure, for example, a convolution layer in a neural network model may perform a convolution operation. Specifically, a convolution kernel (also called filter, weight, and the like) is applied to an input feature map (also called input data, neuron, or input neuron) to perform convolution processing, thus performing feature extraction.

A piece of input data with a size of 6×6×3 is exemplarily shown in the figure, where the input data may represent three input feature maps with a size of 6×6 (a three-dimensional matrix with a size of 6×6×3), which represent three different features. In this embodiment, a width W of the feature map is 6, and a height H of the feature map is also 6. A count of input feature maps may be called an input channel count Ci. For example, there are three input feature maps in the figure, and the three feature maps are also called three feature channels or three input channels.

A convolution kernel with a size of 2×3×3×3 is also exemplarily shown in the figure, where the convolution kernel may represent two three-dimensional convolution kernels with a size of 3×3×3 (two three-dimensional matrices with a size of 3×3×3). Each three-dimensional convolution kernel (also called filter) has three different two-dimensional convolution kernels with a size of 3×3, and the three different two-dimensional convolution kernels correspond to three different input feature maps. A count of three-dimensional convolution kernels may be called an output channel count Co. In this embodiment, the count of the three-dimensional convolution kernels is 2. In each three-dimensional convolution kernel, a count of two-dimensional convolution kernels may be called an input channel count Ci, which is the same as the channel count of the input feature map. Each two-dimensional convolution kernel has a corresponding width Kw and a corresponding height Kh, and in this embodiment, both the Kw and Kh are 3.

The convolution result of the input feature map and the filter is to output two feature maps with a size of 4×4. The convolution result of the input feature map and the above three-dimensional convolution kernel is to obtain the above one output feature map with a size of 4×4. The convolution result of the input feature map and the below three-dimensional convolution kernel is to obtain the below one output feature map with a size of 4×4. A value at each position in the output feature map is obtained by performing a two-dimensional convolution operation on a corresponding block of each input feature map and a corresponding convolution kernel and then summing corresponding results. For example, the figure shows that a value (also called convolution output point) at (0,0) in the above output feature map is obtained by performing a two-dimensional convolution operation on a block framed by a black cube box in the input feature map and the above three-dimensional convolution kernel to obtain three values and then summing the three values to obtain a final value.

In an embodiment of the present disclosure, each convolution output point has a corresponding receptive field, and a shape of the receptive field is equal to a shape of a convolution kernel. For example, a receptive field of a convolution output point at (0,0) in the output feature map in the figure is a 3×3×3 black cube box in the figure. A value of each convolution output point corresponds to an element-wise multiply-accumulate result of an input feature map and weight in a receptive field of the convolution output point. It may be understood that in the embodiment of the present disclosure, the receptive field is relative to a single convolution layer. If a feature vector of a certain position in an input feature map of a current layer is computed from an input of a fixed region of a previous layer, this region is a receptive field of this position.

In order to obtain outputs of other positions, a position of a convolution kernel in the input feature map may be moved; in other words, a receptive field of a convolution output point is moved. In the example of the figure, a convolution stride (Sx, Sy) is (1,1), and a value at (0,1) or (1,0) in the above output feature map may be obtained respectively by performing a convolution operation after moving a convolution kernel one space to the right in the horizontal direction (width direction) or down in the vertical direction (height direction).

It may be known from the above description that in one convolution layer of a neural network, there is one group of input feature maps, totally including H×W×Ci pieces of information, where H is a height of the input feature map, W is a width of the input feature map, and Ci is a count of input feature maps, which is also called an input channel count. There are Ci×Co convolution kernels with a size of Kh×Kw in the convolution layer, where Ci is an input channel count, Co is a count of output feature maps (or an output channel count), and Kh is a height of the convolution kernel, and Kw is a width of the convolution kernel. There are Ho×Wo×Co pieces of information in the output feature map, where Ho is a height of the output feature map, Wo is a width of the output feature map, and Co is an output channel count. Besides, during a convolution operation, a convolution stride (Sx, Sy) is also involved, and a size of the convolution stride may affect a size of the output feature map.

In an embodiment of the present disclosure, dimensions of multi-dimensional data involved are represented as (N, H, W, C) or (Co, H, W, Ci), which represents a storage order of the data in a memory. It may be understood that, although the multi-dimensional data has multiple dimensions, since the layout of the memory is always one-dimensional, there is a correspondence between the multi-dimensional data and the storage order in the memory. The multi-dimensional data is usually allocated in continuous storage spaces. In other words, the multi-dimensional data may be extended in one dimension and stored in the memory in sequence. For example, in an embodiment of the present disclosure, an initial input feature map may be sequentially stored in a low-dimension(here, C/Ci is the lowest dimension)-priority manner; and in order to optimize a convolution operation, a storage order of the input feature map may be adjusted during the operation, as described in detail later. Adjacent dimensions refer to adjacent dimensions in dimension information representations of the multi-dimensional data. For example, W and Ci are adjacent, and the adjacent dimensions may also be called continuous dimensions.

In order to make full use of bandwidth and meet throughput requirements of an operator array, it is usually necessary to perform vectorized alignment of data. For the design of the artificial intelligence chip, a Ci dimension is usually used as a lowest dimension; in other words, the above NHWC dimension order is usually used, and data on the Ci dimension is continuous. Therefore, according to requirements of the vectorized alignment, a size of the Ci dimension is required to be aligned to a specified value, such as an alignment value Aci, so that data is accessed by taking the alignment value Aci as a unit. Based on different designs, the Aci may have different values, such as 64, 128, 256, 512, and the like. Usually, a size of an input port of the operator array is also related to this alignment value. For example, when a bit width of input data is symmetrical, the size of the input port of the operator array is usually twice the alignment value; in other words, input feature map data and weight data of the alignment value Aci scale are processed at one time. When the Ci dimension of the input feature map is relatively large, it is easier to meet the above alignment requirements.

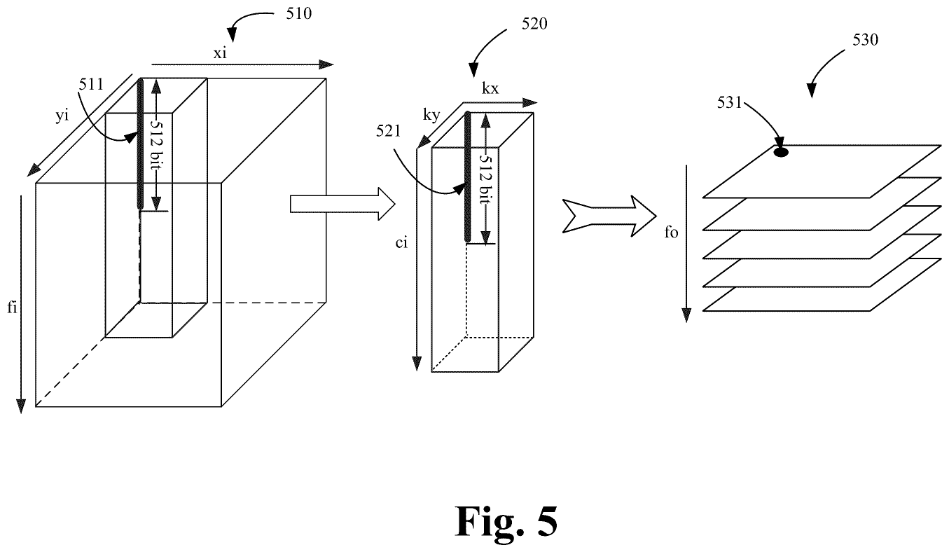

FIG. 5 shows a convolution operation process according to an embodiment of the present disclosure. In this embodiment, a Ci (which is expressed as fi in the figure) dimension of an input feature map is large, so only a part of data is taken each time for operation, such as the amount of data that meets the maximum processing capacity of an operator at one time, thus not only making full use of computing power of the operator, but also saving operation time. In this example, it is assumed that an alignment value is 512 bits; in other words, one line (one cacheline) of data read at one time is required to be 512 bits. For the sake of description, in an example of the present disclosure, assuming that data bit widths of an input feature map and a weight are the same, such as 8 bits or 16 bits, one cacheline may contain 64 pieces of 8-bit data or 32 pieces of 16-bit data.

As shown in the figure, a scale of an input feature map 510 is large, and an input channel dimension fi exceeds 512 bits, such as a multiple of 512; an input channel dimension Ci of a weight 520 is equal to a size of the input channel dimension fi of the input feature map 510 and also exceeds 512 bits. Therefore, each time, one line of input data 511 may be read from the input feature map 510 and one line of weight data 521 may be read from the weight 520 as convolution kernel data, and the two perform an element-wise multiply-accumulate operation to obtain a partial sum 531 in a convolution result 530.

It may be known from the description in FIG. 4 above that a value of each convolution output point corresponds to an element-wise multiply-accumulate result of an input feature map and a weight in a receptive field of the convolution output point. Through multiple access and element-wise multiply-accumulate operations, input data lines and weight lines traverse the whole receptive field at the same time to obtain a plurality of partial sums, then the plurality of partial sums are accumulated, and a value of a convolution output point corresponding to this receptive field may be obtained.

It may be seen that a process of computing each partial sum in the convolution operation above has parallelism, so with proper hardware configuration, by taking full advantage of parallel processing possibility, operations may be accelerated, and efficiency may be improved. Additionally, due to the movement of the convolution kernel during the convolution process, which is the movement of the receptive field, some pieces of data are reused in the process of computing partial sums, so if the reuse of the data may be properly utilized, data throughput during the operation may be further reduced, thus improving efficiency.

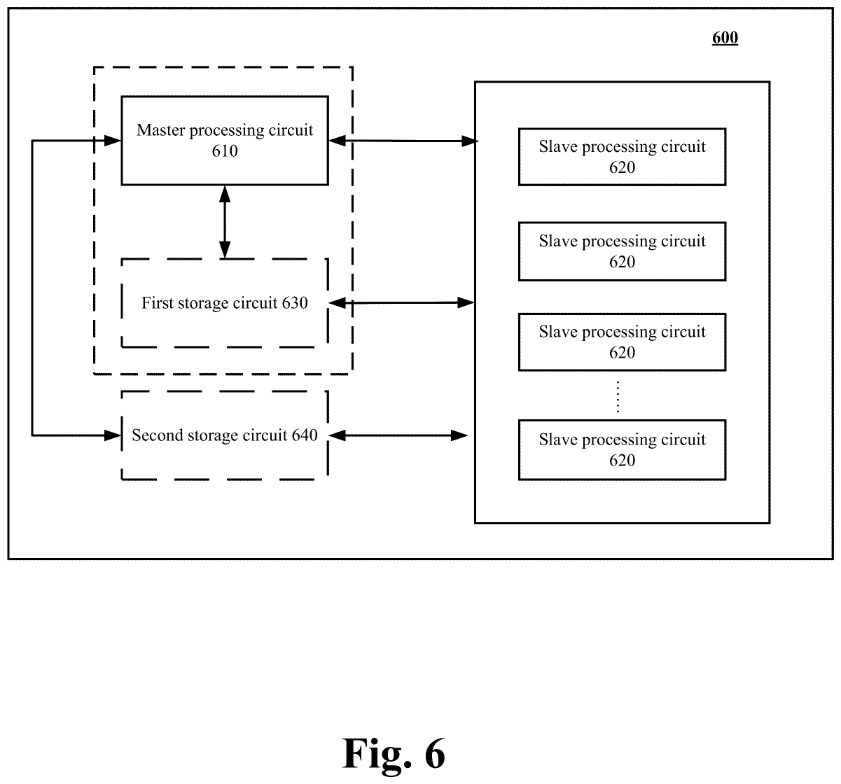

FIG. 6 shows a schematic structural diagram of a computing apparatus 600 according to an embodiment of the present disclosure. It may be understood that this structure may be viewed as a refinement of an internal structure of an operation unit of a single processing core shown in FIG. 3, or a functional division block diagram based on combination of a plurality of operation units of the processing core shown in FIG. 3. As shown in FIG. 6, the computing apparatus 600 of the present disclosure may be configured to perform a convolution operation and may include a master processing circuit 610 and a plurality of slave processing circuits 620. The master processing circuit and the slave processing circuits may communicate with each other through various connections, and the plurality of slave processing circuits may also communicate with each other through various connections.

The master processing circuit and the slave processing circuits may cooperate with each other to realize parallel operation processing. In this configuration, the master processing circuit may, for example, be configured to perform preprocessing on input data, such as splitting the data; and the plurality of slave processing circuits receive intermediate results and perform subsequent processing to obtain a final operation result of an operation instruction. The slave processing circuits may, for example, be configured to perform intermediate operations on corresponding data (such as the split data) in parallel according to an operation instruction to obtain a plurality of intermediate results, and transfer the plurality of intermediate results to the master processing circuit.

In different application scenarios, a connection among the plurality of slave processing circuits may be either a hard connection arranged by hard wires or a logical connection configured according to, for example, a microinstruction, to form multiple types of topology structures of slave processing circuit arrays. The present disclosure has no limitation in this aspect.

By setting the computing apparatus 600 to a master-slave structure (such as a one-master-multi-slave structure, or a multi-master-multi-slave structure, which is not limited in this disclosure), for a computing instruction of a forward operation, data may be split according to the computing instruction, so that a parallel operation is performed on a part with a large computing amount through a plurality of slave processing circuits to improve operation speed, save operation time, and further reduce power consumption.

In order to support operation functions, the master processing circuit and the slave processing circuits may include various computing circuits, such as a vector operation unit and a matrix operation unit. The vector operation unit is configured to perform a vector operation and supports complex operations, such as vector multiplication, addition, and nonlinear conversion. The matrix operation unit is responsible for core computing of deep learning algorithms, which includes matrix multiplication and convolution.

In some embodiments, the master processing circuit 610 may broadcast at least one feature map block of an input feature map to a plurality of scheduled slave processing circuits during a convolution operation, where the feature map block is obtained by dividing the input feature map into blocks according to a lowest storage dimension. At this time, each scheduled slave processing circuit 620 may perform a convolution operation on the broadcast feature map block and a corresponding weight block, where the weight block is obtained by dividing a weight into blocks according to an output channel dimension; and return an operation result to the master processing circuit. The above lowest storage dimension may, for example, be an input channel Ci dimension.

Depending on different hardware configurations and/or other considerations, the above dividing processing of the input feature map and weight may be performed in different locations and at different times.

In some embodiments, the master processing circuit may include a dividing function, which is used to divide the input feature map and weight, respectively. For example, the master processing circuit may read an input feature map and weight of an original storage format from an external storage circuit (such as double data rate (DDR)), then divide and store the input feature map according to the lowest storage dimension, and divide and store the weight according to the output channel dimension, so that the scheduled slave processing circuits load corresponding weight blocks. The above dividing process may be performed either during or before the operation to prepare data.

In some embodiments, the master processing circuit may include a partial dividing function, which is used to divide only an input feature map prepared to be broadcast, while a weight prepared to be distributed may be divided into blocks through an external dividing circuit.

In some embodiments, the master processing circuit may not include or perform a dividing function at all. In these embodiments, the input feature map and weight are divided into blocks by a dividing circuit independent of the master processing circuit. The input feature map and weight after division may be stored in corresponding storage circuits.

In some implementations, when broadcasting the feature map block, the master processing circuit 610 may align the feature map block to a first alignment requirement in the lowest storage dimension, where this first alignment requirement is determined according to processing capacity of the slave processing circuit. For example, depending on the maximum throughput of the operator array in the slave processing circuit, the first alignment requirement may, for example, be equal to the maximum throughput, so that the entire operator array may be utilized.

In an example, the first alignment requirement may, for example, be 64 bytes, which refer to 512 bits. As such, each aligned feature map block has a size of 64 bytes in the lowest storage dimension. Sizes of the feature map block in other storage dimensions are all 1 data bit. For example, for a three-dimensional feature map, assuming that a data bit width is 8 bits, the three-dimensional feature map may be divided into a feature map block containing 64 pieces of data and with a shape of 64×1×1. Assuming that a data bit width is 16 bits, the three-dimensional feature map may be divided into a feature map block containing 32 pieces of data and with a shape of 32×1×1.

In order to perform a convolution operation with the divided feature map block, the weight is also required to be divided. It may be known from the description in FIG. 4 that the weight has one more dimension than the input feature map: an output channel Co dimension, so the division of the weight is slightly different from that of the input feature map.

In some embodiments, the weight may be first divided into a plurality of weight blocks according to the Co dimension, where each weight block corresponds to a piece of weight data of output channel. It may be understood that each weight block corresponds to a three-dimensional convolution kernel (such as the three-dimensional convolution kernel shown in FIG. 4). Therefore, convolution operation processing may be performed in parallel on different slave processing circuits for different weight blocks. According to the above convolution principle, it may be understood that convolution results on different output channels are not required to be accumulated, so each slave processing circuit may perform operation processing independently.

Each weight block may be divided in a similar manner to the input feature map; in other words, each weight block may be divided into a plurality of weight lines according to the lowest storage dimension (such as the Ci dimension). Similarly, the weight lines are also aligned to the first alignment requirement in the lowest storage dimension, so that feature map blocks and weight lines may perform the element-wise multiply-accumulate operation.

When the weight lines and feature map blocks traverse a receptive field of a certain convolution output point at the same time to perform the element-wise multiply-accumulate operation, a plurality of partial sums may be obtained, and a sum of these partial sums is a final value of this convolution output point.

In some embodiments of the present disclosure, by using different data paths to transfer input feature maps and weights, multiple multiplexing methods of the input feature maps and weights may be supported, thus reducing data throughput during the operation and improving processing efficiency.

Specifically, the computing apparatus 600 may further include a first storage circuit 630 and a second storage circuit 640, which are configured to separately store data transferred by different data paths.

The first storage circuit 630 may be configured to store and multicast data; in other words, data in the first storage circuit is transferred to a plurality of slave processing circuits via a broadcast bus, and these slave processing circuits receive the same data. It may be understood that broadcast and multicast may be realized through the broadcast bus. The multicast refers to a communication mode in which a copy of data is transferred to a plurality of slave processing circuits, while the broadcast refers to a communication mode in which a copy of data is transferred to all slave processing circuits. The broadcast is a special case of the multicast. Since both the multicast and broadcast correspond to one-to-many transmission modes, the two are not specifically distinguished in the present disclosure. The broadcast and multicast may be referred to as multicast, and those skilled in the art may determine its meaning according to the context.

The second storage circuit 640 may be configured to store and distribute data; in other words, data in the second storage circuit is separately transferred to different slave processing circuits, and each slave processing circuit receives different data.

By providing the first storage circuit and the second storage circuit separately, transmission of to-be-operated data in different transmission modes may be supported, thus reducing data throughput by multiplexing multicast data among a plurality of slave processing circuits.

In some embodiments, the master processing circuit may cache the input feature map in the first storage circuit 630 to broadcast the divided feature map block to the plurality of scheduled slave processing circuits during the operation. Correspondingly, the master processing circuit may perform block storage of the weight in the second storage circuit 640 as described above, where the weight block may be distributed to a corresponding slave processing circuit before operation.

It may be understood that although each processing circuit and storage circuit are shown as discrete units in FIG. 6, the storage circuit and processing circuit may also be combined into one unit according to different configurations. For example, the first storage circuit 630 may be combined with the master processing circuit 610, and the second storage circuit 640 may be shared by the plurality of slave processing circuits 620 and allocate a separate storage area for each slave processing circuit to speed up access. The present disclosure has no limitation in this aspect. Additionally, in this computing apparatus, the master processing circuit and the slave processing circuits may belong to different units of the same processor or chip, or to different processors, and the present disclosure has no limitation in this aspect.

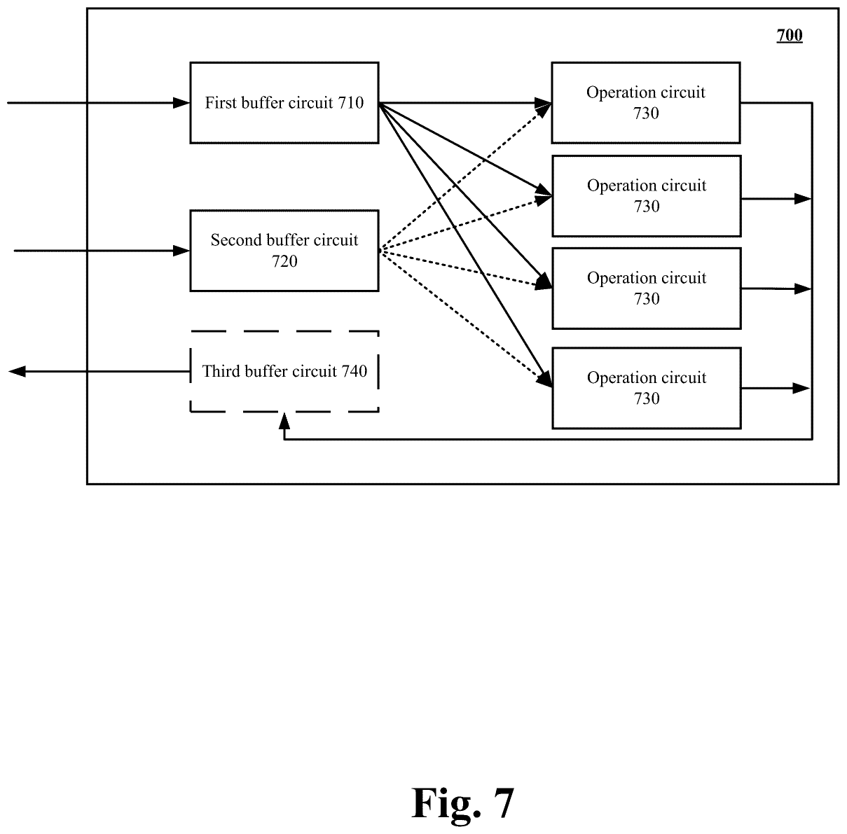

FIG. 7 shows a schematic diagram of an internal structure of a slave processing circuit according to an embodiment of the present disclosure. As shown in the figure, a slave processing circuit 700 includes a first buffer circuit 710, a second buffer circuit 720, and a plurality of operation circuits 730.

The first buffer circuit 710 may be configured to cache and process a weight or input feature map. Accordingly, the second buffer circuit 720 may be configured to cache and process the input feature map or weight. Both the two buffer circuits are configured to select data involved in the operation. Data from the first buffer circuit 710 may come from, for example, the first storage circuit 630 or the second storage circuit 640 in FIG. 6. Correspondingly, data from the second buffer circuit 720 may come from, for example, the second storage circuit 640 or the first storage circuit 630 in FIG. 6.

In some embodiments, the first buffer circuit 710 is configured to cache weight lines in a weight block from the second storage circuit. These weight lines are formed by dividing the weight block according to a lowest storage dimension (such as a Ci dimension) in the second storage circuit, for example, in accordance with the previously described alignment in the lowest storage dimension to the first alignment requirement. These weight lines may be distributed to corresponding operation circuits 730 during the operation.

In some embodiments, the second buffer circuit 720 is configured to cache feature map blocks in an input feature map that are from the first storage circuit and broadcast by the master processing circuit. These feature map blocks may be broadcast to all operation circuits 730 in the slave processing circuit 700 during the operation.

Each operation circuit 730 may be configured to perform an element-wise multiply-accumulate operation on a weight line distributed from the first buffer circuit 710 and a feature map block broadcast from the second buffer circuit 720.

The slave processing circuit 700 may further include a third buffer circuit 740 configured to cache an operation result of each operation circuit 730.

It may be understood that although there are four operation circuits 730 in the figure, according to different hardware configurations, more or fewer operation circuits may be included in the salve processing circuit, which is not limited in this disclosure embodiment.

As mentioned earlier, in some embodiments, the speed of data access may be accelerated by rationally allocating a storage mode of each piece of data.

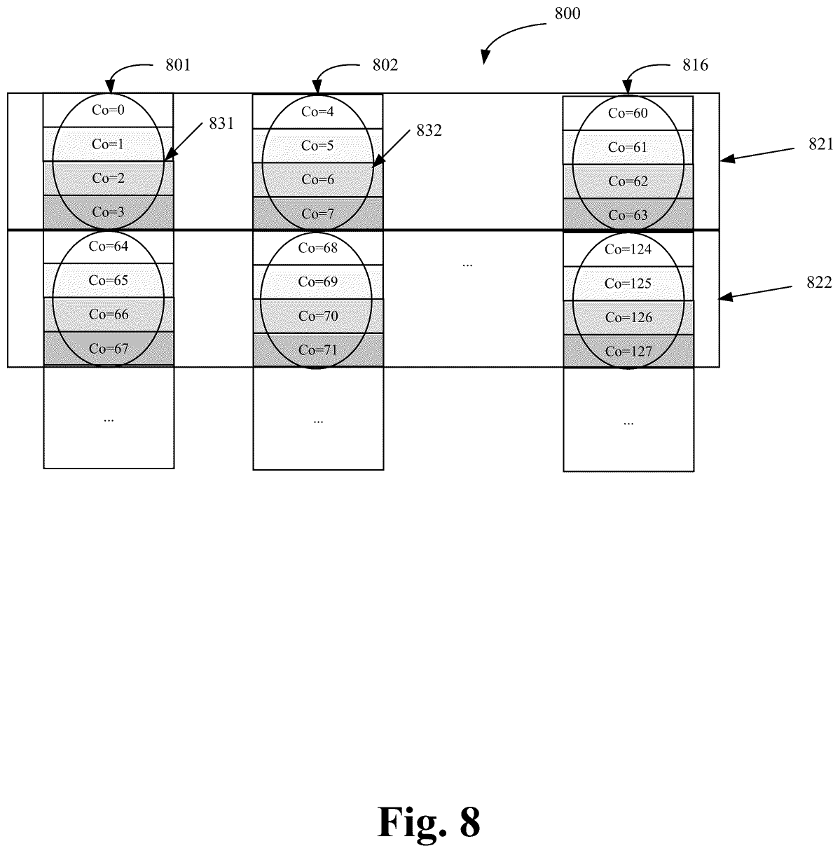

FIG. 8 shows an exemplary storage manner of weight data in a second storage circuit according to an embodiment of the present disclosure.

As shown in the figure, a second storage circuit 800 may allocate a storage area for each slave processing circuit, so that a weight required by each slave processing circuit is only required to be read from its corresponding storage area. The figure exemplifies the allocation of 16 storage areas 801˜816 for 16 slave processing circuits. In each storage area, a weight block to be processed by this slave processing circuit is stored. It may be understood that depending on different hardware configurations, a count of slave processing circuits may vary, such as 4, 8, 32, or more. In the example of FIG. 8, each slave processing circuit includes 4 operation circuits, which is not limited in the present disclosure.

As method earlier, operation results on the Co dimension are not required to be accumulated, so Co dimensions distributed in different operation circuits may be operated independently. As such, weights on different Co dimensions may be stored in each storage area; in other words, different weight blocks may be stored in each storage area. In the example in the figure, weight blocks in the 16 storage areas correspond to different Co dimensions.

When a size of the Co dimension exceeds a count of schedulable slave processing circuits, the Co dimension is required to be operated through multiple rounds of operations. A weight block used in each round may be sequentially grouped according to the round of operation, and a count of weight blocks in each weight block group corresponds to a total operation capacity of scheduled slave processing circuits in a corresponding round of operation.

Taking the example in the figure as an example, assuming that a total of 16 slave processing circuits may be scheduled, and each slave processing circuit includes 4 operation circuits, then a total of 64 operation circuits may be scheduled in each round of operation, and 64 Co dimensions are operated separately. Further, assuming that the size of the Co dimension of the weight is 128, which exceeds the total number of schedulable operation circuits, which is 64, all computing may be completed by two rounds of operations. In a first round of operation, 64 operation circuits are targeted at weights of Co=0, 1, . . . , 63; In a second round of operation, these 64 operation circuits are targeted at weights of Co=64, 65, . . . , 127. Therefore, the weight may be divided into 128 weight blocks according to the Co dimension. The first 64 weight blocks may be a first weight block group 821, and the last 64 weight blocks may be a second weight block group 822.

Further, since the second storage circuit allocates storage areas according to the slave processing circuits, and each slave processing circuit includes a plurality of operation circuits, in some embodiments, weight blocks in each weight block group may be sequentially segmented according to the scheduled slave processing circuits in the corresponding round of operation, where each weight block segment corresponds to one scheduled slave processing circuit, and each weight block segment is separately stored in a storage area allocated for the corresponding slave processing circuit in the second storage circuit. Each weight block segment includes at least one weight block; in other words, each slave processing circuit corresponds to more than one weight block. Optionally, a count of weight blocks included in each weight block segment is equal to a count of operation circuits included in each slave processing circuit.

As shown in the figure, in the first weight block group 821, 64 weight blocks are sequentially divided into 16 weight block segments according to 16 slave processing circuits, where a first weight block segment 831 including four weight blocks Co=0,1,2,3 is allocated to a first slave processing circuit, where the four weight blocks are separately allocated to four operation circuits in the first slave processing circuit; a second weight block segment 832 including four weight blocks Co=4,5,6,7 is allocated to a second slave processing circuit, where the four weight blocks are separately allocated to four operation circuits in the second slave processing circuit, and so on. In the second weight block group 822, weight blocks are divided into weight block segments similarly and then stored accordingly, which will not be repeated here.

The above has described a hardware structure of the computing apparatus and an exemplary storage manner of data of the present disclosure. The above hardware structure may provide different data paths for input feature maps and weights involved in the operation, so that by using different data transmission modes (such as broadcast, multicast, distribution, and the like), data throughput during the operation is reduced and operation efficiency is improved. In an actual operation, different multiplexing methods may be adopted according to scale characteristics of data involved in the operation, where the multiplexing methods include weight multiplexing and/or input feature map multiplexing.

In some embodiments, an input feature map may be multiplexed in all operation circuits of the same slave processing circuit, while each operation circuit performs operations on weight blocks corresponding to different output channels and the input feature map. At this time, the input feature map is broadcast to all operation circuits, while each operation circuit may load a weight of a corresponding output channel in advance.

In some implementations, each scheduled slave processing circuit may read a weight line of each weight block in a weight block segment allocated to the slave processing circuit in a current round of operation from the second storage circuit in turn according to the allocated Co dimension value. The read weight line is then cached in the first buffer circuit of the slave processing circuit. Before the operation, the slave processing circuit may distribute weight lines to different operation circuits in the slave processing circuit according to a Co dimension corresponding to each weight line. During the operation, the slave processing circuit may broadcast feature map blocks in the second buffer circuit to each operation circuit. As such, the operation circuit may perform an element-wise multiply-accumulate operation on the distributed weight line and the broadcast feature map block to obtain a partial sum result of a receptive field corresponding to the weight line and feature map block.

Taking the example in FIG. 8 as an example, in a storage area allocated by the second storage circuit for each slave processing circuit, four weights of Co are stored consecutively. The first slave processing circuit may read data in turn in the Co direction. For example, in a first step of operation, the first slave processing circuit may first read a first weight line of Co=0, then a first weight line of Co=1, a first weight line of Co=2, and finally a first weight line of Co=3. In a next step of operation, the first slave processing circuit may first read a second weight line of Co=0, then a second weight line of Co=1, a second weight line of Co=2, and finally a second weight line of Co=3.

The read weight lines are stored in the first buffer circuit and distributed to different operation circuits based on the Co. For example, a weight line of Co=0 is sent to a first operation circuit, and a weight line of Co=1 is sent to a second operation circuit, and so on.

The slave processing circuit broadcasts feature map blocks cached in the second buffer circuit to all operation circuits in the slave processing circuit. Each operation circuit of the slave processing circuit obtains a partial sum of a first receptive field of a corresponding Co in the first step of operation respectively.

In order to obtain all partial sum results of the whole receptive field and then obtain a final result of a convolution output point corresponding to the receptive field, it is necessary to traverse the whole receptive field, acquire corresponding weight lines and feature map blocks multiple times, and perform element-wise multiply-accumulate operations on the weight lines and feature map blocks to obtain a plurality of partial sum results, where these partial sum results are accumulated to obtain the final result of the corresponding convolution output point.

During the traversal process, different multiplexing methods may be adopted. Accordingly, the slave processing circuit may control the reading of content from the first buffer circuit and the second buffer circuit depending on the multiplexing method of the weight and/or input feature map.

In some implementations, when weight multiplexing is adopted, which means that the same weight line may be used for a plurality of different input feature map blocks, the slave processing circuit may continuously broadcast feature map blocks corresponding to different convolution output points/receptive fields in the input feature map cached in the second buffer circuit to a plurality of operation circuits in the slave processing circuit. Here, a count of different convolution output points/receptive fields is equal to weight multiplexing times SR. For example, when the SR=2, a first feature map block corresponding to, for example, a first convolution output point and a second feature map block corresponding to a second convolution output point may be continuously broadcast to all four operation circuits in the slave processing circuit.

In these implementations, each operation circuit may perform element-wise multiply-accumulate operations respectively on the same weight line and the continuously broadcast feature map blocks to obtain SR partial sum results belonging to different convolution output points.

In multiple rounds of operations, partial sum results obtained each time belonging to the same convolution output point may be accumulated until all partial sum results obtained by traversing the corresponding receptive field are accumulated, so that a final result of this convolution output point is obtained.

It may be understood that the SR may be different according to specific situations. For example, the SR may be 2, 4, 8 . . . The SR is limited by a read bandwidth of the second storage circuit and a read port count of the second storage circuit. For example, when the read bandwidth of the second storage circuit is 64 bytes and the port count is 1, at least 64 bytes of data in 1 beat are read to the first buffer circuit, and at most 64 bytes of data in 8 beats are read. At this time, the SR is up to 32.

Optionally or additionally, in some implementations, input feature map multiplexing may be adopted; in other words, the same feature map block may be used for a plurality of different weight lines. Here, the input feature map multiplexing means that the same input feature map in a single operation circuit is used to perform operations with different weight lines multiple times. In the embodiment described above, the input feature map multiplexing refers to multiplexing in all operation circuits; in other words, the same input feature map performs operations respectively with different weight lines in a plurality of operation circuits.

When the input feature map multiplexing is adopted in a single operation circuit, the slave processing circuit may read one weight line from each weight block in the weight block segment allocated to the slave processing circuit according to the Co dimension, where a count of read weight lines is equal to a product of input feature map multiplexing times NR and a count of operation circuits in the slave processing circuit. Then, the read weight lines may be cached in the first buffer circuit and distributed to each operation circuit.

In these implementations, each operation circuit may perform element-wise multiply-accumulate operations respectively on NR weight lines distributed by the first buffer circuit and the feature map block broadcast from the second buffer circuit to obtain NR partial sum results belonging to different Co dimensions.

Taking the example in FIG. 8 as an example, 128 weight blocks of Co are stored in the second storage circuit, and in a storage area allocated to each slave processing circuit, there are 8 weight blocks of Co. When the NR=2, for example, for the first slave processing circuit, one weight line is taken from each of eight weight blocks at one time and stored in the first buffer circuit during reading. Two results of Co are computed in each operation circuit of the first slave processing circuit; in other words, each feature map block is multiplexed twice. For example, results of Co=0 and Co=64 are computed by a first operation circuit, and results of Co=1 and Co=65 are computed by a second operation circuit, and so on. As such, 16×4×2=128 results of Co may be computed simultaneously by 16 slave processing circuits. It may be understood that depending on how Co is allocated, it is also possible for each operation circuit to process two weight lines of Co in sequence. For example, results of Co=0 and Co=1 are computed by the first operation circuit. The present disclosure has no limitation in this respect. It may also be understood that when the Co exceeds 128, it is also necessary to traverse the Co dimension and repeatedly send input feature map blocks, and the slave processing circuits read weight lines corresponding to different Co.

Similarly, in the multiple rounds of operations, partial sum results obtained each time belonging to the same Co dimension may be accumulated to obtain a convolution output corresponding to the Co.

It may be understood that the NR may be different according to specific situations. For example, the NR may be 2, 4, 8 . . . The NR is limited by the capacity of the first buffer circuit. For example, 9×64B of data may be stored in the first buffer circuit. Without the input feature map multiplexing, 4×64B of weights are stored, which correspond to 4 operation circuits respectively. When the input feature map is multiplexed, 8×64B of weights are stored, and every 2×64B corresponds to 1 operation circuit. Therefore, in this example, limited by the first buffer circuit, the NR is 2 at most.

The weight multiplexing and input feature map multiplexing in the single operation circuit described above may be used alone or in combination. No matter which multiplexing method is adopted, the master processing circuit may concatenate operation results returned from the plurality of scheduled slave processing circuits in the multiple rounds of operations according to dividing and multiplexing methods to obtain a final result. Specifically, partial sum results belonging to the same Co dimension and the same receptive field are accumulated to obtain a result of a convolution output point corresponding to the receptive field in the Co dimension.

As mentioned earlier, the master processing circuit may, for example, receive intermediate results from the plurality of slave processing circuits and perform subsequent processing to obtain a final operation result. Specifically, in the above embodiment, the master processing circuit may be configured to concatenate operation results of slave processing circuits dealing with different Co dimensions to obtain a convolution operation result on the whole Co dimension.

In other embodiments, each slave processing circuit that completes a convolution operation of a single Co dimension through multiple rounds of operations may accumulate a partial sum result in each round of operation according to a corresponding convolution output point/receptive field and then return to the result the master processing circuit.

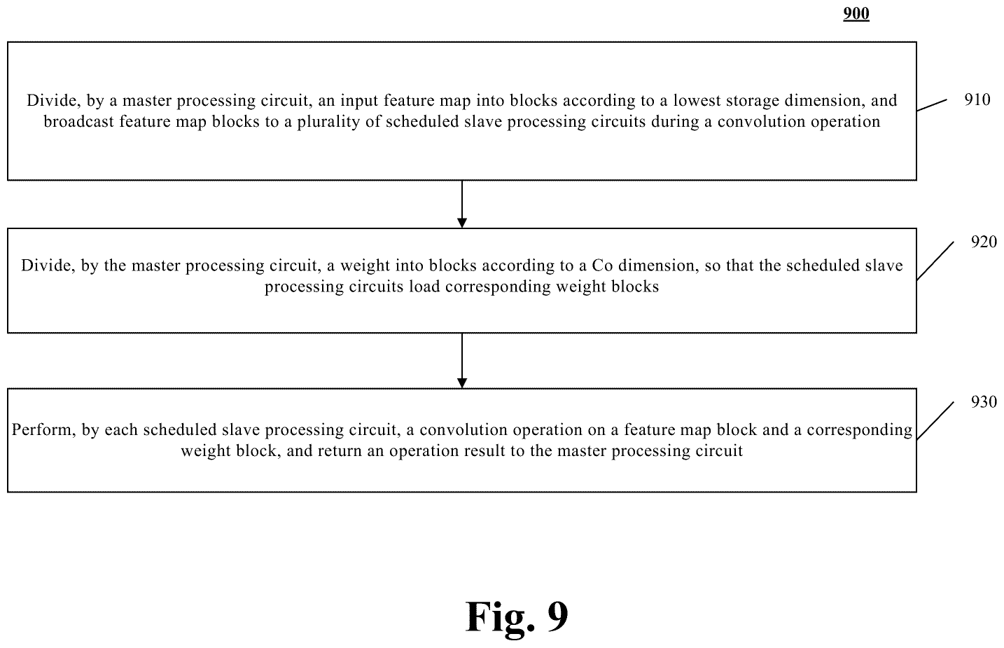

The embodiment of the present disclosure also provides a method for performing a convolution operation by using the above computing apparatus. FIG. 9 shows an exemplary flowchart of a convolution operation method 900 according to an embodiment of the present disclosure.

As shown in the figure, in step 910, a master processing circuit divides an input feature map into blocks according to a lowest storage dimension and broadcasts feature map blocks to a plurality of scheduled slave processing circuits during a convolution operation. In step 920, the master processing circuit divides a weight into blocks according to a Co dimension, so that the scheduled slave processing circuits load corresponding weight blocks. In step 930, each scheduled slave processing circuit performs a convolution operation on a feature map block and a corresponding weight block, and returns an operation result to the master processing circuit.

It may be understood by those skilled in the art that steps described in the method flowchart correspond to circuits of the computing apparatus described in combination with FIGS. 4-6, and therefore features described above are also applicable to the method steps and will not be repeated here. Although the convolution operation method of the embodiment of the present disclosure is described above in the sequence of the method flowchart, it may be understood by those skilled in the art that these method steps may also be performed in other sequences or simultaneously. For example, the step 910 and step 920 may be performed simultaneously, or the step 920 may be performed before the step 910.

The present disclosure also provides a chip, including the computing apparatus of any embodiment described above with reference to the drawings. Further, the present disclosure also provides a board card, including the above chip.

According to different application scenarios, an electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograma electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented in other ways that are not disclosed in the present disclosure. For example, for units in the aforementioned electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the direct or indirect coupling relates to a communication connection using an interface, where the communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in the embodiments of the present disclosure. Additionally, in some scenarios, the plurality of units in the embodiments of the present disclosure may be integrated into one unit, or each of the units may be physically separated.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a central processing unit (CPU), a graphics processing unit (GPU), a field-programmable gate array (FPGA), a digital signal processor (DSP), and an application-specific integrated circuit (ASIC), and the like. Further, the storage unit or the storage apparatus may be any appropriate storage medium (including a magnetic storage medium or a magneto-optical storage medium, and the like), such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), a read only memory (ROM), and a random access memory (RAM), and the like.

The foregoing may be better understood according to following articles:

Article 1. A computing apparatus configured to perform a convolution operation, where the computing apparatus includes a master processing circuit and a plurality of slave processing circuits, where
the master processing circuit is configured to:
broadcast at least one feature map block of an input feature map to a plurality of scheduled slave processing circuits during the convolution operation, where the feature map block is obtained by dividing the input feature map into blocks according to a lowest storage dimension; and
each scheduled slave processing circuit is configured to:
perform the convolution operation on the feature map block and a corresponding weight block, where the weight block is obtained by dividing a weight into blocks according to an output channel dimension; and
return an operation result to the master processing circuit.

Article 2. The computing apparatus of article 1, where the master processing circuit is further configured to:
divide the input feature map into blocks according to the lowest storage dimension during the convolution operation.

Article 3. The computing apparatus of article 1 or 2, where the master processing circuit is further configured to:
align the feature map block to a first alignment requirement in the lowest storage dimension when broadcasting the feature map block, where the first alignment requirement is determined according to a processing capacity of the slave processing circuit.

Article 4. The computing apparatus of article 3, where the first alignment requirement is equal to a maximum data processing capacity of an operation circuit in the slave processing circuit at one time, and a size of each aligned feature map block in the lowest storage dimension is equal to the maximum data processing capacity at one time.

Article 5. The computing apparatus of any one of articles 1-4, where the master processing circuit is further configured to:
divide the weight into blocks according to the output channel dimension, so that the scheduled slave processing circuits load corresponding weight blocks.

Article 6. The computing apparatus of article 5, where the master processing circuit is further configured to:
group a plurality of weight blocks continuously divided in the output channel dimension in sequence according to rounds of operations, where a count of weight blocks in each weight block group corresponds to a total operation capacity of scheduled slave processing circuits in a corresponding round of operation;
segment the weight blocks in each weight block group in sequence according to the scheduled slave processing circuits in the corresponding round of operation, where each weight block segment corresponds to one scheduled slave processing circuit; and
store each weight block segment in a storage area allocated for a corresponding slave processing circuit respectively.

Article 7. The computing apparatus of any one of articles 1-6, where each slave processing circuit further includes a first buffer circuit, a second buffer circuit, and a plurality of operation circuits, where
the first buffer circuit is configured to cache one or a plurality of weight lines divided according to the lowest storage dimension in at least one weight block corresponding to the slave processing circuit, where the weight line is distributed to a corresponding operation circuit during the operation; and
the second buffer circuit is configured to cache the feature map block broadcast by the master processing circuit, where the feature map block is broadcast to all operation circuits in the slave processing circuit during the operation, where
each operation circuit is configured to perform an element-wise multiply-accumulate operation on the weight line distributed from the first buffer circuit and the feature map block broadcast from the second buffer circuit.

Article 8. The computing apparatus of article 7, where the slave processing circuit is further configured to:
read a weight line of each weight block in a weight block segment allocated to the slave processing circuit in a current round of operation in turn according to the output channel dimension;
cache the read weight line in the first buffer circuit; and
distribute the weight line to different operation circuits in the slave processing circuit according to an output channel dimension corresponding to each weight line to perform the element-wise multiply-accumulate operation with the feature map block broadcast from the second buffer circuit to obtain a partial sum result corresponding to a convolution output point.

Article 9. The computing apparatus of article 8, where the slave processing circuit is further configured to: control the reading of content from the first buffer circuit and the second buffer circuit depending on a multiplexing method of the weight and/or input feature map, so that the weight line and the feature map block simultaneously traverse the entire receptive field of the convolution output point to perform the element-wise multiply-accumulate operation to obtain and then accumulate a plurality of partial sum results to obtain a convolution output corresponding to the convolution output point.

Article 10. The computing apparatus of article 9, where
the slave processing circuit is further configured to continuously broadcast feature map blocks corresponding to different convolution output points in the input feature map cached in the second buffer circuit to the plurality of operation circuits, where a count of the different convolution output points is equal to weight multiplexing times SR; and
each operation circuit is further configured to:
perform element-wise multiply-accumulate operations respectively on the same weight line and the continuously broadcast feature map blocks to obtain SR partial sum results belonging to the different convolution output points; and
accumulate partial sum results belonging to the same convolution output point and obtained in multiple rounds of operations to obtain the convolution output corresponding to the convolution output point.

Article 11. The computing apparatus of any one of articles 9-10, where
the slave processing circuit is further configured to:
read one weight line from each weight block in the weight block segment allocated to the slave processing circuit according to the output channel dimension, where a count of read weight lines is equal to a product of input feature map multiplexing times NR and a count of operation circuits in the slave processing circuit; and
cache the read weight lines in the first buffer circuit and distribute the read weight lines to the plurality of operation circuits; and
each operation circuit is further configured to:
perform element-wise multiply-accumulate operations respectively on NR weight lines distributed by the first buffer circuit and the feature map block broadcast from the second buffer circuit to obtain NR partial sum results belonging to different output channel dimensions; and
accumulate partial sum results belonging to the same output channel dimension and obtained in the multiple rounds of operations to obtain a convolution output corresponding to the output channel dimension.

Article 12. The computing apparatus of any one of articles 1-11, where the master processing circuit is further configured to: concatenate operation results returned by the plurality of scheduled slave processing circuits in the multiple rounds of operations according to dividing and multiplexing methods to obtain a final result.

Article 13. A chip, including the computing apparatus of any one of articles 1-12.

Article 14. Board card, including the chip of article 12.

Article 15. A method for implementing a convolution operation by using the computing apparatus of any one of articles 1-12.

The embodiments of the present disclosure have been described in detail above. The present disclosure explains principles and implementations of the present disclosure with specific examples. Descriptions of the embodiments above are only used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

What is claimed:

1. A computing apparatus configured to perform a convolution operation, wherein the computing apparatus comprises a master processing circuit and a plurality of slave processing circuits, wherein
the master processing circuit is configured to:
broadcast at least one feature map block of an input feature map to a plurality of scheduled slave processing circuits during the convolution operation, wherein the feature map block is obtained by dividing the input feature map into blocks according to a lowest storage dimension; and
each scheduled slave processing circuit is configured to:
perform the convolution operation on the feature map block and a corresponding weight block, wherein the weight block is obtained by dividing a weight into blocks according to an output channel dimension; and
return an operation result to the master processing circuit.

2. The computing apparatus of claim 1, wherein the master processing circuit is further configured to:
divide the input feature map into blocks according to the lowest storage dimension during the convolution operation.

3. The computing apparatus of claim 2, wherein the master processing circuit is further configured to:
align the feature map block to a first alignment requirement in the lowest storage dimension when broadcasting the feature map block, wherein the first alignment requirement is determined according to a processing capacity of the slave processing circuit.

4. The computing apparatus of claim 3, wherein the first alignment requirement is equal to a maximum data processing capacity of an operation circuit in the slave processing circuit at one time, and a size of each aligned feature map block in the lowest storage dimension is equal to the maximum data processing capacity at one time.

5. The computing apparatus of claim 1, wherein the master processing circuit is further configured to:
divide the weight into blocks according to the output channel dimension, so that the scheduled slave processing circuits load corresponding weight blocks, wherein
the weight block is divided into a plurality of weight lines according to the lowest storage dimension, and the weight lines are aligned to a first alignment requirement in the lowest storage dimension, wherein the first alignment requirement is determined according to a processing capacity of the slave processing circuit.

6. The computing apparatus of claim 5, wherein the master processing circuit is further configured to:
group a plurality of weight blocks continuously divided in the output channel dimension in sequence according to rounds of operations, wherein a count of weight blocks in each weight block group corresponds to a total operation capacity of scheduled slave processing circuits in a corresponding round of operation;
segment the weight blocks in each weight block group in sequence according to the scheduled slave processing circuits in the corresponding round of operation, wherein each weight block segment corresponds to one scheduled slave processing circuit; and
store each weight block segment in a storage area allocated for a corresponding slave processing circuit respectively.

7. The computing apparatus of claim 1, wherein each slave processing circuit further comprises a first buffer circuit, a second buffer circuit, and a plurality of operation circuits, wherein
the first buffer circuit is configured to cache one or a plurality of weight lines divided according to the lowest storage dimension in at least one weight block corresponding to the slave processing circuit, wherein the weight line is distributed to a corresponding operation circuit during the operation; and
the second buffer circuit is configured to cache the feature map block broadcast by the master processing circuit, wherein the feature map block is broadcast to all operation circuits in the slave processing circuit during the operation, wherein
each operation circuit is configured to perform an element-wise multiply-accumulate operation on the weight line distributed from the first buffer circuit and the feature map block broadcast from the second buffer circuit.

8. The computing apparatus of claim 7, wherein the slave processing circuit is further configured to:
read a weight line of each weight block in a weight block segment allocated to the slave processing circuit in a current round of operation in turn according to the output channel dimension;
cache the read weight line in the first buffer circuit; and
distribute the weight line to different operation circuits in the slave processing circuit according to an output channel dimension corresponding to each weight line, wherein the weight line is configured to perform the element-wise multiply-accumulate operation with the feature map block broadcast from the second buffer circuit to obtain a partial sum result corresponding to a convolution output point.

9. The computing apparatus of claim 8, wherein the slave processing circuit is further configured to:
control the reading of content from the first buffer circuit and the second buffer circuit depending on a multiplexing method of the weight and/or the input feature map, so that the weight line and the feature map block simultaneously traverse the entire receptive field of the convolution output point to perform the element-wise multiply-accumulate operation to obtain and then accumulate a plurality of partial sum results to obtain a convolution output corresponding to the convolution output point.

10. The computing apparatus of claim 9, wherein
the slave processing circuit is further configured to continuously broadcast feature map blocks corresponding to different convolution output points in the input feature map cached in the second buffer circuit to the plurality of operation circuits, wherein a count of the different convolution output points is equal to weight multiplexing times SR; and
each operation circuit is further configured to:
perform element-wise multiply-accumulate operations respectively on the same weight line and the continuously broadcast feature map blocks to obtain SR partial sum results belonging to the different convolution output points; and
accumulate partial sum results belonging to the same convolution output point and obtained in multiple rounds of operations to obtain the convolution output corresponding to the convolution output point.

11. The computing apparatus of claim 9, wherein
the slave processing circuit is further configured to:
read one weight line from each weight block in the weight block segment allocated to the slave processing circuit according to the output channel dimension, wherein a count of read weight lines is equal to a product of input feature map multiplexing times NR and a count of operation circuits in the slave processing circuit; and
cache the read weight lines in the first buffer circuit and distribute the read weight lines to the plurality of operation circuits; and
each operation circuit is further configured to:
perform element-wise multiply-accumulate operations respectively on NR weight lines distributed by the first buffer circuit and the feature map block broadcast from the second buffer circuit to obtain NR partial sum results belonging to different output channel dimensions; and
accumulate partial sum results belonging to the same output channel dimension and obtained in multiple rounds of operations to obtain a convolution output corresponding to the output channel dimension.

12. The computing apparatus of claim 1, wherein the master processing circuit is further configured to:
concatenate operation results returned from the plurality of scheduled slave processing circuits in multiple rounds of operations according to dividing and multiplexing methods to obtain a final result.

13. A chip, comprising a computing apparatus, wherein the computing apparatus comprises a master processing circuit and a plurality of slave processing circuits, wherein
the master processing circuit is configured to:
broadcast at least one feature map block of an input feature map to a plurality of scheduled slave processing circuits during a convolution operation, wherein the feature map block is obtained by dividing the input feature map into blocks according to a lowest storage dimension; and
each scheduled slave processing circuit is configured to:
perform the convolution operation on the feature map block and a corresponding weight block, wherein the weight block is obtained by dividing a weight into blocks according to an output channel dimension; and
return an operation result to the master processing circuit.

14. A board card that includes a chip, comprising a computing apparatus, wherein the computing apparatus comprises a master processing circuit and a plurality of slave processing circuits, wherein
the master processing circuit is configured to:
broadcast at least one feature map block of an input feature map to a plurality of scheduled slave processing circuits during a convolution operation, wherein the feature map block is obtained by dividing the input feature map into blocks according to a lowest storage dimension; and
each scheduled slave processing circuit is configured to:
perform the convolution operation on the feature map block and a corresponding weight block, wherein the weight block is obtained by dividing a weight into blocks according to an output channel dimension; and
return an operation result to the master processing circuit.

15. (canceled)
